(19) United States
(12) Patent Application Publication
(10) Pub. No.: US 2012/0050907 A1
(43) Pub. Date: Mar. 1, 2012

(54) DETECTION OF PROXIMITY BETWEEN A SENSOR AND AN OBJECT

(75) Inventor: Kenneth A. Haapala, Plymouth, MN (US)

(73) Assignee: SEAGATE TECHNOLOGY LLC, Scotts Valley, CA (US)

(21) Appl. No.: 12/869,081

(22) Filed: Aug. 26, 2010

(51) Int. Cl. G11B 5/02

(52) U.S. Cl. 360/59; G9B/5.026

(57) ABSTRACT

An apparatus includes a sensor having a heater. The apparatus also includes a proximity detection component that analyzes a sensed signal, obtained from the sensor during application of an alternating current signal to the heater of the sensor, and responsively provides an output indicative of whether proximity exists between the sensor and an object that causes the sensor to produce the sensed signal.

### BACKGROUND

The present embodiments relate to proximity detection, and more particularly to a technique, using alternating current signal injection, for sensing proximity (near-contact and contact) between a sensor (for example, a read mechanism such as a slider) and an object (for example, a storage medium in a data storage device).

Mass storage devices are one of many components of modern computers. One type of mass storage device is a disc drive. A typical disc drive includes a head disc assembly (HDA) that has one or more magnetic discs which are rotated by a spindle motor at a substantially constant high speed and accessed by an array of read/write heads which store data on tracks defined on the disc surfaces. Each head is carried by a slider, which is designed to “fly” just over the surface of the rotating disc. Each slider is a part of a head-gimbal assembly (HGA), which also includes a suspension (beam and gimbal strut) for positioning the slider and an interconnect (for example, a flexible circuit) that carries electrical signals between the head and drive electronics. A printed circuit board assembly (PCBA), which includes electronics used to control the operation of the HDA, is typically mounted to the underside of the HDA to complete the disc drive.

As the density of data recorded on magnetic discs continues to increase, it is becoming necessary for the spacing between the head carried by the slider and the disc to decrease to very small distances. Spacings of well below 10 nano-meters (nm) are required in some applications. In disc drive systems having such small slider-disc spacing, the possibility of contact between the slider and the disc is relatively high, due to factors such as slider manufacturing process limitations and limited air-bearing modeling capabilities. A system for detecting such contacts in disc drive and other applications is useful for a number of diagnostic tests, enabling assessments such as component-level flyability and durability, drive-level reliability, and production-level screening to be made, as well as providing input to fly-height calibration and adaptive-fly-control systems that enable dynamic adjustment of flying height in certain disc drive systems.

Accurate contact detection allows fly height to be controlled more precisely and is one part of optimizing a head to achieve a low bit-error rate (BER) at a high bit density to enable increased drive capacity. The risks of contact detection both in the field and as a factory calibration is that if contact is not sensed early enough, head wear (burnish) could occur, shortening the life of the head. Conversely, if contact is declared to early, as in a false detect, the active fly clearance will be set too high, negatively impacting BER and drive capacity.

### SUMMARY

An aspect of the disclosure relates to detecting proximity (near-contact or contact) between a sensor (for example, a read mechanism such as a slider) and an object (for example, a data storage medium) by analyzing a sensed signal from the sensor.

One apparatus embodiment includes a sensor having a heater. The apparatus also includes a proximity detection component that analyzes a sensed signal, obtained from the sensor during application of an alternating current signal to the heater of the sensor, and responsively provides an output indicative of whether proximity exists between the sensor and an object that causes the sensor to produce the sensed signal. In this embodiment, the heater mechanically displaces at least a portion of the sensor vertically in response to the application of the alternating current signal.

In another apparatus embodiment, a circuit includes a proximity detection component that analyzes a sensed signal, obtained from a sensor during the application of an alternating current signal to a heater of the sensor, and responsively provides an output indicative of whether proximity exists between the sensor and an object that causes the sensor to produce the sensed signal. In this embodiment, the sensor is electrically coupled to a suspension that supports the sensor via a low impedance coupling.

In still another embodiment, an apparatus includes a first circuit that provides an alternating current signal to a heater of a sensor, the alternating current signal causes the heater of the sensor to mechanically displace the sensor vertically. The apparatus also includes a second circuit that analyzes a sensed signal, obtained from the sensor during the application of the alternating current signal to the heater of the sensor, and responsively provides an output indicative of whether proximity exists between the sensor and an object that causes the sensor to produce the sensed signal.

These and various other features and advantages will become apparent upon reading the following detailed description and upon reviewing the associated drawings.

### BRIEF DESCRIPTION OF THE DRAWINGS

FIG. 1 is a simplified diagrammatic illustration of a circuit that includes elements for detecting proximity between a sensor (for example, a read mechanism such as a slider) and an object (for example, a storage medium in a data storage device) in accordance with some of the present embodiments.

FIG. 2 is a block diagram of a specific embodiment a disc drive data storage system employing a preamplifier that is capable of providing alternating current signal injection to a heater of a slider.

FIG. 3 is a diagrammatic representation of a simplified top view of a disc.

FIGS. 4-18 are different plots related to the present embodiments.

FIG. 19 is a block diagram of a data storage device in which slider-disc proximity can be determined in accordance with one embodiment.

### DETAILED DESCRIPTION

Exemplary embodiments relate to sensing proximity (near-contact and contact) between a sensor (for example, a read mechanism such as a slider) and an object (for example, a storage medium in a data storage device). More particularly, exemplary embodiments of the sensor-object proximity detection scheme that are described below analyze a sensed signal, obtained from a sensor during the application of an alternating current signal to a heater of the sensor, and provide an output indicative of whether proximity exists between the sensor and the object that causes the sensor to produce the sensed signal.

In different embodiments, different signal components or combinations of components of the sensed signal can be used to determine sensor-object proximity while an alternating current signal is being applied to a heater of the sensor, for example. In data storage systems such as disc drives, examples of different components of the sensed signal that can be used to determine slider-disc proximity are an automatic gain control (AGC) signal component and a position error signal (PES) component. Details about the utilization of these components to determine slider-disc proximity in disc drives are provided further below.

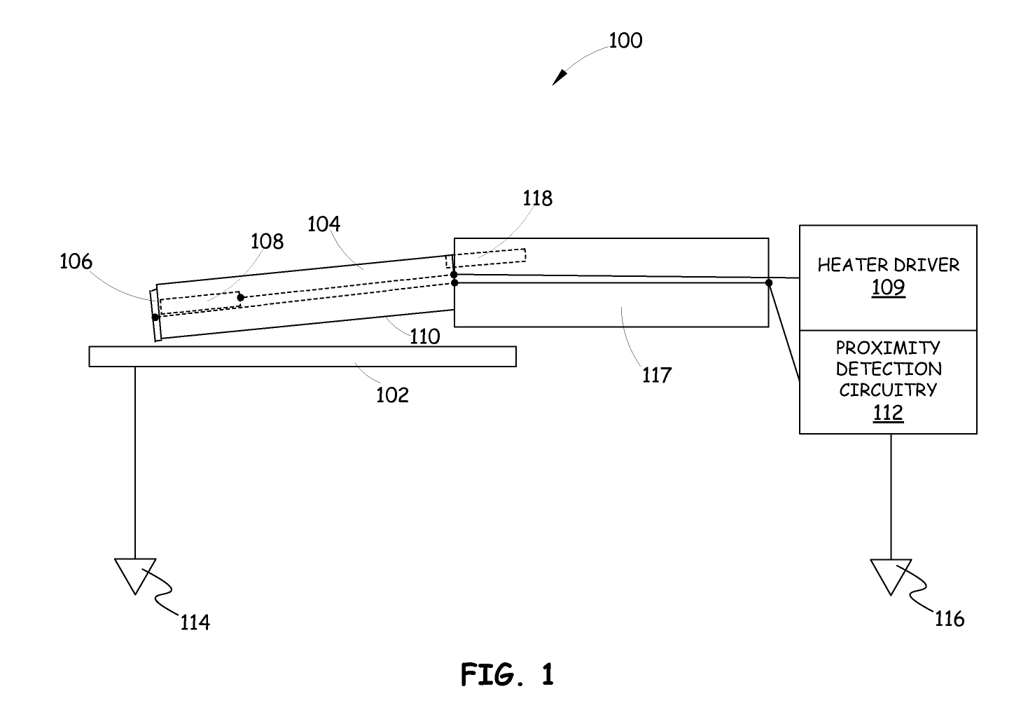

FIG. 1 is a simplified diagrammatic illustration of a data storage system (for example, a disc drive) that includes a circuit for determining proximity between a sensor and an object in the data storage system. System 100 of FIG. 1 includes a data storage disc 102 and a slider 104 that “flies” over the disc 102. A suspension 117 supports slider 104 and is also electrically connected to slider 104 by a low impedance electrical connection 118. An actuator (not shown in FIG. 1) moves the suspension 117 and thus helps position slider 104 at a desired location above a surface of disc 102. Slider 104 includes a transducer 106 (which can include a read head or a read/write head, for example) that interacts with the data storage disc 102. A bearing surface such as an air bearing surface (ABS) 110 of the slider 104 faces the disc 102. A heater 108, included in slider 104, is used to generate heat and therefore cause thermal expansion of at least a portion of slider 104 to adjust a flying height of the slider 104 over the data storage disc 102. Heater 108 can comprise a resistor that is connected to a heater driver 109, which may be a part of, or separate from, a slider-disc proximity detection circuit 112. In FIG. 1, inverted triangles 114 and 116 represent a ground of the data storage system circuit. Utilizing low impedance electrical connection 118 is one exemplary method of providing a return path to ground for current that passes through heater 108 included in slider 104.

In operation, proximity detection component or circuit 112 analyzes the sensed signal (for example, a readback signal), obtained from the transducer carried by slider 104 during the application of an alternating current signal to heater 108 by heater driver 109, and responsively provides an output indicative of whether proximity exists between the slider 104 and disc 102. In some embodiments, specific components of a readback signal such as AGC and PES components, which are described in detail further below, are analyzed by component 112 to determine slider-disc proximity.

The sensing system of one or more of the present embodiments may be used in a number of disc drive and non-disc drive related applications. It may be employed in a spin-stand tester for assessing component-level flyability and durability. It might also be used for drive-level reliability assessment of disc drives, both in their early mechanical phases and in fully functional drives. Screening of suspensions or head gimbal assemblies (HGAs) in pre-production phases as well as production phases is possible with the present embodiments, whether the HGA employs a conventional metal gimbal or a “flex” (polymer-based) gimbal. Although the proximity sensing system may be implemented independently of systems that control the flying height of the slider, the output of proximity detection component 112 may be useful as an input to fly-height calibration and adaptive-fly-control systems that enable dynamic adjustment of flying height in certain disc drive systems. Those skilled in the art will recognize that still further applications exist for the system of the present embodiments due to its versatility and broad level of efficacy. For example, although the embodiment of FIG. 1 describes proximity detection between a slider and a data storage medium, the sensed signal analysis technique described in connection with FIG. 1 can be utilized for proximity detection between any transducer mechanism (which may be structurally and functionally substantially different from a slider, but employs a heater capable of receiving an AC signal), that produces a sensed signal, and an object such as a data storage medium. In general, a proximity detection component or circuit (such as 112) is capable of analyzing a sensed signal from any suitable sensor, during the application of an alternating current signal to a heater of the sensor, and responsively providing an output indicative of whether proximity exists between the sensor and an object that causes the sensor to produce the sensed signal. Slider 104 is only a specific example of a sensor, and data storage medium 102 is only a specific example of an object. Also, a proximity detection component or circuit (such as 112) can be used in systems other than data storage systems.

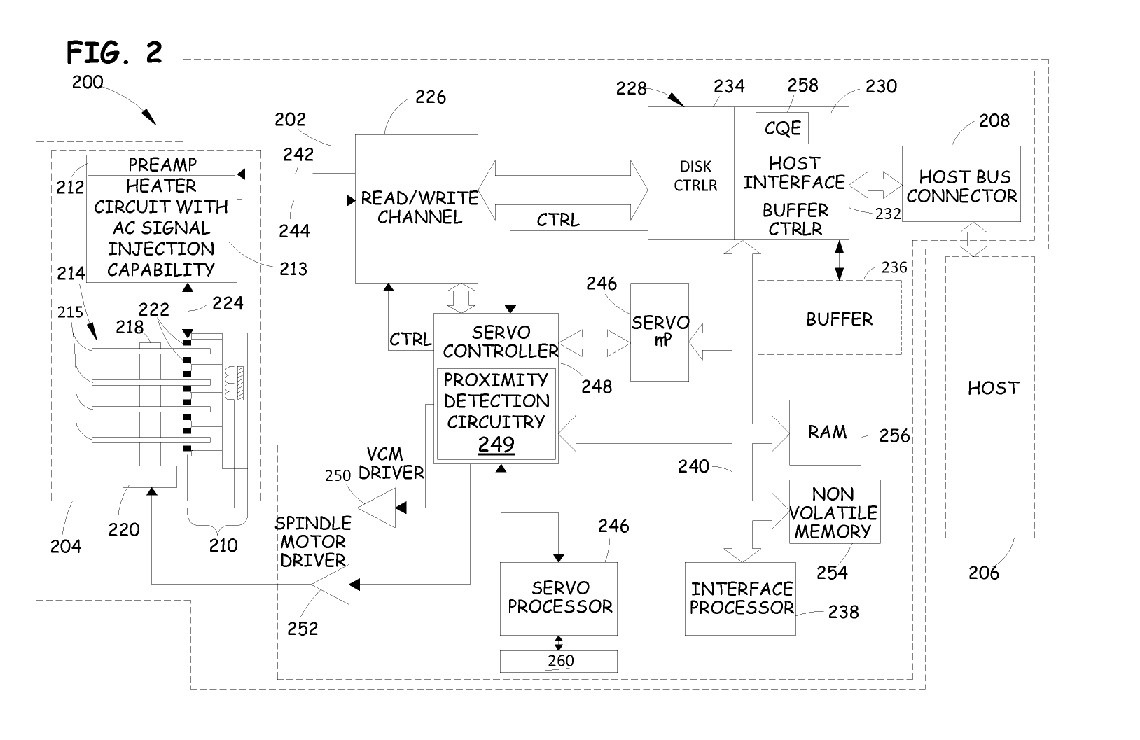

Referring now to FIG. 2, a specific exemplary embodiment of a disc drive data storage system employing a preamplifier that is capable of providing AC signal injection to a heater of a slider is shown. Disc storage system 200 includes a printed circuit board assembly (PCBA) 202 and a head-disc assembly (HDA) 204. PCBA 202 includes circuitry and processors, which provide a target interface controller (or drive controller) for communicating between a host system 206 and HDA 204. Host system 206 can include a microprocessor-based data processing system such as a personal computer or other system capable of performing a sequence of logical operations. Data is transmitted between host system 206 and PCBA 202 via a host bus connector 208. HDA 204 includes an actuator assembly 210, a preamplifier 212, and a disc assembly 214. Disc assembly 214 includes one or more media discs 215, stacked on a spindle assembly 218. Spindle assembly 218 is mechanically coupled to a spindle motor 220 for rotating the disc(s) at a high rate of speed.

Actuator assembly 210 includes a voice coil motor, and multiple actuator arms. Located at the end of each actuator arm are one or more sliders/transducer heads such as 222, which are associated with a respective disc surface. Transducer heads 222 communicate with disc controller circuit board 202 via a cable assembly 224 connected to preamplifier 212 for reading and writing data to the transducer head's associated disc surface. Preamplifier 212 provides an amplified signal to a read/write channel 226 of PCBA 202. Read/write channel 226 performs encoding and decoding of data written to and read from the disc.

A servo processor 246 provides intelligent control of actuator assembly 210 and spindle motor 220 through a servo controller 248. By commands issued to servo controller 248 by servo processor 246, VCM driver 250 is coupled to move actuator assembly 210 and spindle motor driver 252 is coupled to maintain a constant spin rate of spindle motor 220.

PCBA 202 includes a host interface disc controller (HIDC) application-specific integrated circuit (ASIC) 228. ASIC 228 includes a host interface 230, a buffer controller 232, and a disc controller 234. Host interface 230 communicates with host system 206 via host bus connector 208 by receiving commands and data from and transmitting status and data back to host system 206. A command cueing engine (CQE) 258 is incorporated in host interface 230.

Buffer controller 232 controls a non-volatile buffer memory 236. Disc controller 234 tracks the timing of data sectors passing under a currently selected transducer head and accordingly sends data to and receives data from read/write channel 226. Disc controller 234 also provides for error correction and error detection on data transmitted to and read from discs 214.

An interface processor 238 manages a queue of commands received from host 106 with the assistance of the CQE 258 embedded in host interface 230. Interface processor 238 interfaces with functional elements of PCBA 202 over a bus 240, for transfer of commands, data, and status.

Disc system operational programs may be stored in non-volatile program storage memory 254, such as read-only memory (ROM) or flash memory, and are loaded into random access memory (RAM) or program loading memory 256 for execution by interface processor 238. Suitably, servo processor 246 may have integrated or separate memory 260 for storage of servo programs.

As mentioned above, preamplifier 212 provides an amplified signal to a read/write channel 226 of PCBA 202. Further, preamplifier 112 includes fly height control circuitry and associated head-heating circuitry 213. In accordance with some embodiments, head heating circuitry 213 can provide an AC injection signal to heaters in the sliders/heads 222. In some embodiments, which are described in detail further below, applying an AC injection signal with the help of head heating circuitry 213 involves varying digital to analog converter (DAC) values in a register (not shown in FIG. 2) included in, or coupled to, the head heating circuitry 213. In one embodiment, the heater DAC values are varied synchronous to the servo sectors (as defined in the following section). In one embodiment, the DAC values are the instantaneous power values that the head heating circuit 213 applies to the heaters in heads 222. In some embodiments, servo controller 248 includes proximity detection circuitry 249, which analyzes AGC and/or PES components of sensed signals obtained from heads 222, while head-heating circuitry 213 provides an AC injection signal to the heaters in the heads 222, and provides an output indicative of whether slider-disc proximity exists. In another embodiment, the servo processor 246 includes a proximity detection algorithm using digital values of AGC and/or PES. Reasons as to why AGC and PES signals are useful for determining slider-disc proximity and details regarding how slider disc proximity is computed are provided below.

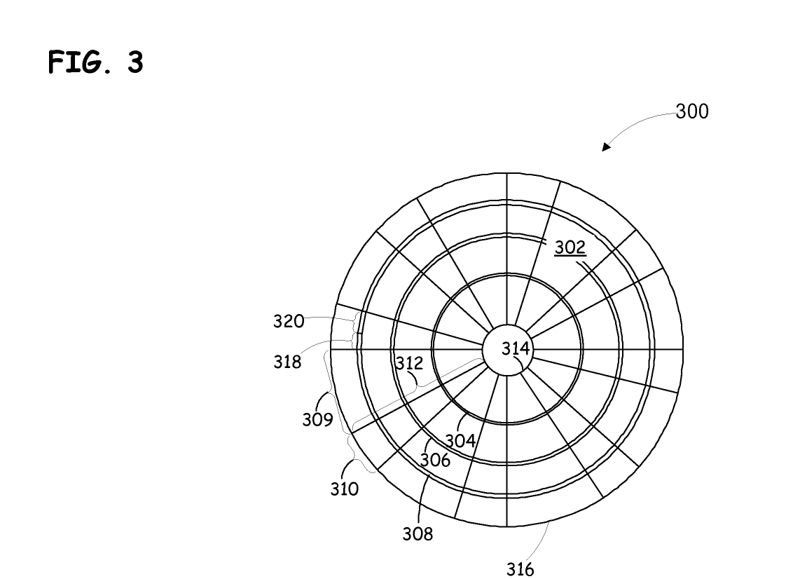

FIG. 3 is a diagrammatic representation of a simplified top view of a disc 300 having a surface 302 which has been formatted to be used in conjunction with a sectored servo system (also known as an embedded servo system) according to a specific example. Disc 300 can be, for example, a single disc of disc pack 214 of FIG. 2. As illustrated in FIG. 3, disc 300 includes a plurality of concentric tracks 304, 306 and 308 for storing data on the disc's surface 302. Although FIG. 3 only shows a small number of tracks (i.e., 3) for ease of illustration, it should be appreciated that typically many thousands of tracks are included on the surface 302 of disc 300.

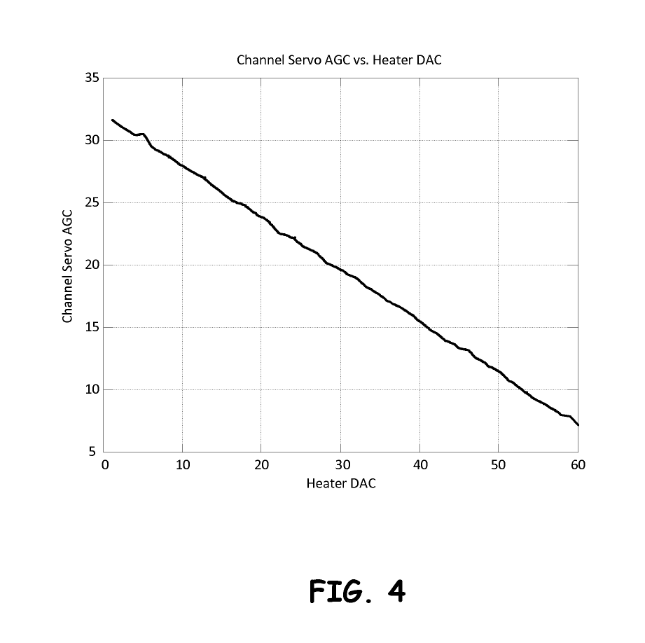

Each track 304, 306 and 308 is divided into a plurality of data sectors 309 and a plurality of servo sectors 310. The servo sectors 310 in each track are radially aligned with servo sectors 310 in the other tracks, thereby forming servo wedges 312 which extend radially across the disc 300 (e.g., from the disc's inner diameter 314 to its outer diameter 316). Each servo sector 310 includes a plurality of fields. In the interest of simplification, only AGC field 318 and PES field 320 are shown. Typically, a sensed signal obtained by reading AGC fields is used for signal amplitude measurements that are, in turn, used for adjusting a gain of subsequently read servo sectors. PES fields 320 include patterns that are typically used to determine a fractional part of a radial position of a head/slider (such as head/slider 222 of FIG. 2). Details regarding how AGC and/or the PES fields are additionally utilized to determine slider-disc proximity are provided below in connection with FIGS. 4-18.

FIG. 4 is a plot of head heater DAC power values versus mean servo AGC values for a given track. The plot shows that the AGC values have an approximate linear relation to head heater DAC setting prior to slider-disc contact. Since heater power setting is known to be inversely proportional to fly height, the mean servo AGC can be used to approximate a change in fly height.

If a head heater power to vertical displacement relationship is known or previously computed, a transfer function of AGC to vertical displacement can be determined from a differential slope relationship such as:

dAGC/dHeat=(AGC2−AGC1)/(Heat2−Heat1) Equation 1

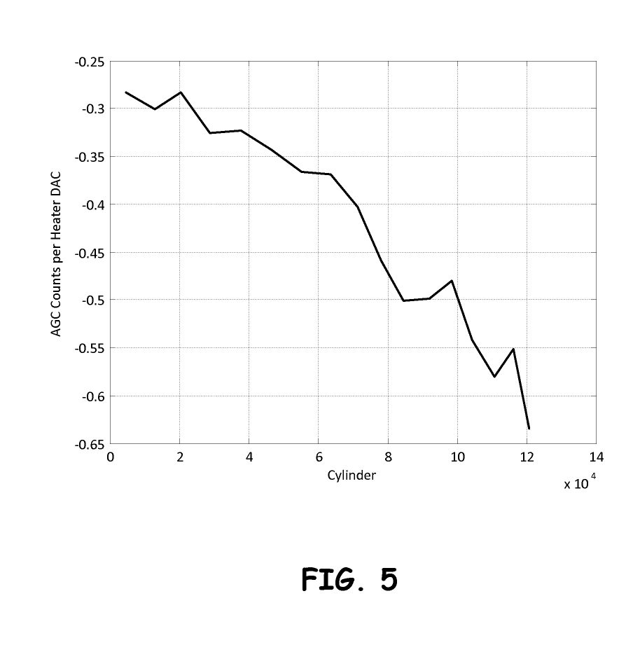

In Equation 1, AGC1 and AGC2 are respective AGC values at any two different points on the plot of FIG. 4 and Heat1 and Heat2 are the two corresponding DAC values at the two different points on the plot of FIG. 4. A sign of the slope (dAGC/dHeat) determined using Equation 1 will be negative, meaning that AGC is inversely proportional to heater power. Also, in general, at constant preamplifier gain, the slope will vary across the radius of the disc. This is shown from empirical data that is plotted in FIG. 5, which is a graph of counts per heater DAC versus disc radius.
Given a constant k in nanometers (nm) per Heater DAC, the number of AGC counts per nanometer can be written as

AGC/nm=dAGC/dHeat*(1/k) Equation 2

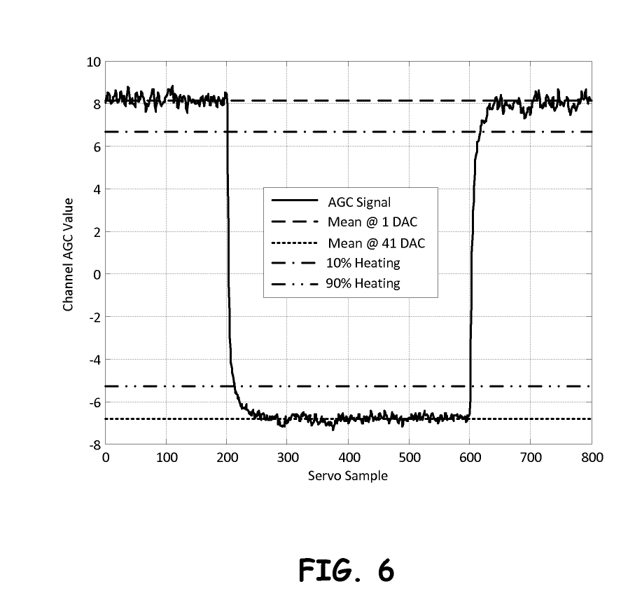

A repeatable portion of an AGC signal is a mean value at each servo sample averaged over multiple disc revolutions. Thus, a small change in the repeatable AGC signal can be used to approximate a change in fly height around a revolution. Averaged time domain samples of multiple revolutions can be considered for a case where a heater power is increased relative to a baseline value for a finite duration (i.e., a pulse is provided to the heater). This is illustrated in FIG. 6, which is a plot showing mean AGC response to a heater pulse.

In FIG. 6, it can be seen that a time constant of the heater (Tao) can be approximated using 10% and 90% rise (fall) time values, as in:

Tao=(T_{10%}−T_{90%})/(ln(0.9)−ln(0.1)) Equation 3

In Equation 3, ln represents a natural logarithm and a computed value of (ln(0.9)−ln(0.1)) is 2.2. From the plot of FIG. 6, heating and cooling time constants are measured in microseconds (us) as:

Tao_{Heating}=241.5us/2.2=110us Equation 4

Tao_{Cooling}=329.0us/2.2=150us Equation 5

From Equations 4 and 5, it is seen that the heating and cooling time constants are not equal due active heating and passive cooling of the head. Also, from the plot of FIG. 6, a dAGC/dHeat slope term can be calculated from the two known heater DAC values and the two measured steady state AGC values.

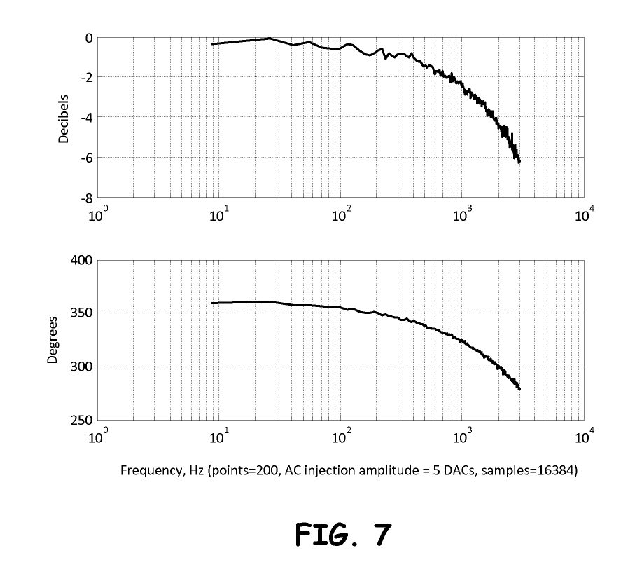

Observation also shows that the averaged AGC to fly height relationship for a small disturbance signal is approximately linear. The concept of a small signal sinusoid as an input to the heater DAC can be used to perform a swept sine (multiple sinusoids, each having a different frequency and each being injected at a different point in time) to measure the heater to fly height transfer function. FIG. 7 shows a result of a swept sine heater transfer function measurement gain and magnitude versus frequency. It should be noted that the plot of FIG. 7 is normalized to 0 dB at direct current (DC) by applying the measured dAGC/dHeat normalization to the measured response.

Based on the plotted result in FIG. 7, a bandwidth of the heater can be determined at a point where the gain crosses −3 dB. The time constant and bandwidth for a first order linear system are related by the following equation:

Tao=1/(2*pi*F) Equation 6

where F is the −3 dB frequency and pi=3.14159265. At F=1280 Hz, Tao=124 us.

A comparison of results in Equations 4 and 5 with and the result Tao=124 us obtained using Equation 6 shows that the time domain results of Equations 4 and 5 are similar to the frequency domain result of Tao=124 us obtained using Equation 6. While the head heater is a higher order system, using the approximation simply validates the measurement results.

In addition, it can be inferred that, at high frequency, an AC injection of heater power results in a small fraction of vertical displacement of a slider for an equivalent DC heater power. The gain rolls off in the transfer function at high frequency, which validates that the actual head/slider protrusion at higher frequencies is a small fraction of the input amplitude to the heater.

The same measurement technique can be repeated with a small signal AC injection while incrementing the DC value of heater power. Near the slider-disc contact point, a gradual change in both the gain and phase response is observed. At higher frequencies, 10-20 times the heater bandwidth, for example, the change in phase is more readily observed.

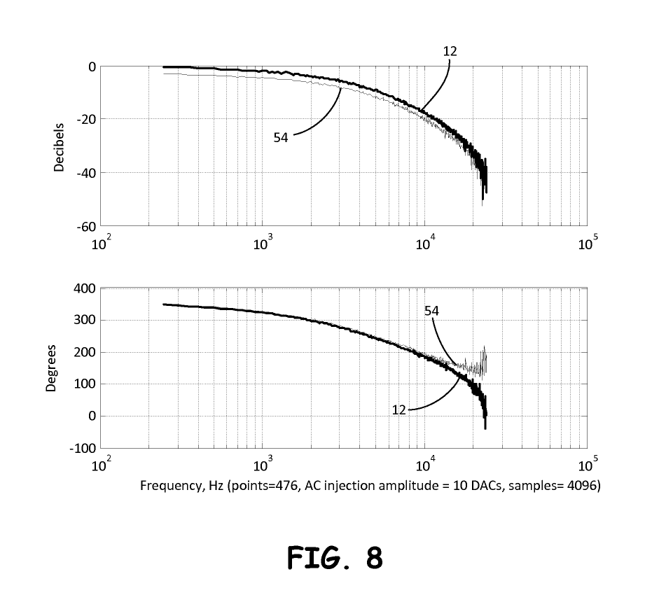

FIG. 8 is a plot that shows heater response (AGC) for slider-disc non-contact and near contact scenarios. The plot of FIG. 8 shows a contact value that was measured to be at 64 DACs using a legacy measurement method. For comparison purposes, a baseline (non-contact) heater DAC (12) and a near contact heater DAC value were chosen (a value of 54 accounts for the 10 DACs of AC injection). In FIG. 8, a reason for a change in phase at near contact may be explained by non-linear effects such as heat transfer due to proximity to the disc lubricant and/or changes in airflow near the contact point.

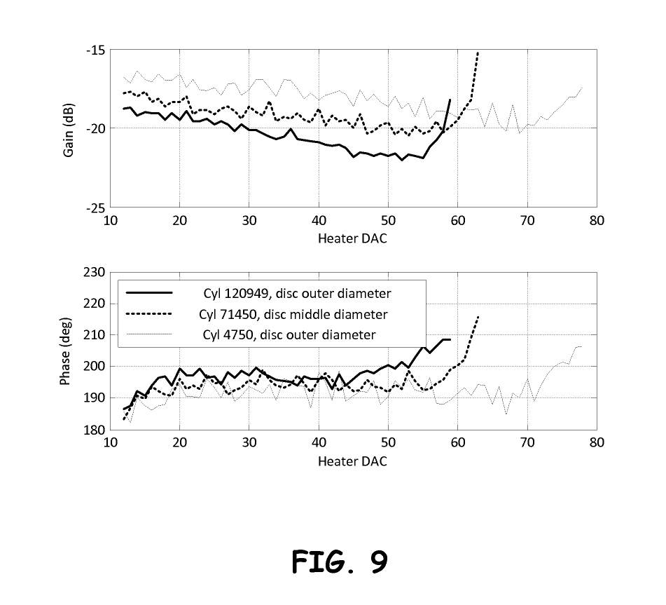

One aspect of one or more embodiments is to inject a high frequency (5-10 times heater bandwidth) AC signal into the heater while incrementing DC heater power and monitoring for a change in the AGC phase (and magnitude). Choosing a higher frequency reduces the transfer function magnitude signal to noise ratio (SNR) but allows a more significant change in phase to be observed. A high frequency injection results in a net vertical displacement that is small, but the gauge repeatability is favorable due to a larger phase change. It should be noted that 20 dB of attenuation at 7 times heater bandwidth results in a net displacement that is less than 1/10 of the injection amplitude. Bench experiments have confirmed that it is possible to detect the magnitude and/or phase change early enough to perform contact detection and proximity sensing. FIG. 9 is a plot of the AGC transfer function gain and phase at 10 kHz versus mean Heater DAC.

One possible proximity-sensing algorithm monitors for an inflection point in the transfer function gain and/or phase at a given frequency while incrementing the heater DAC.

Based on this concept, an algorithm was developed to perform contact detection by injecting a single frequency (10 kHz) and monitoring for a gain change (greater than 2 dB) and phase relative to a fixed threshold (208 degrees). The head to disc interface location was sensed when either the gain or phase change crossed their respective thresholds. Plotting the results relative to the legacy slider-disc contact detection method shows favorable correlation and some points are detected sooner.

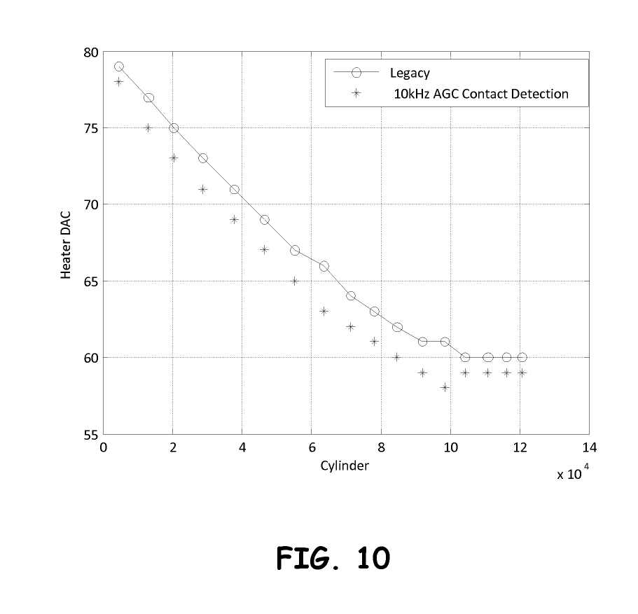

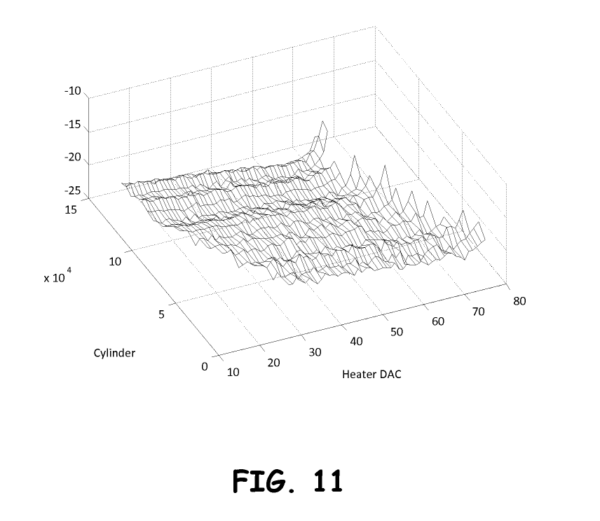

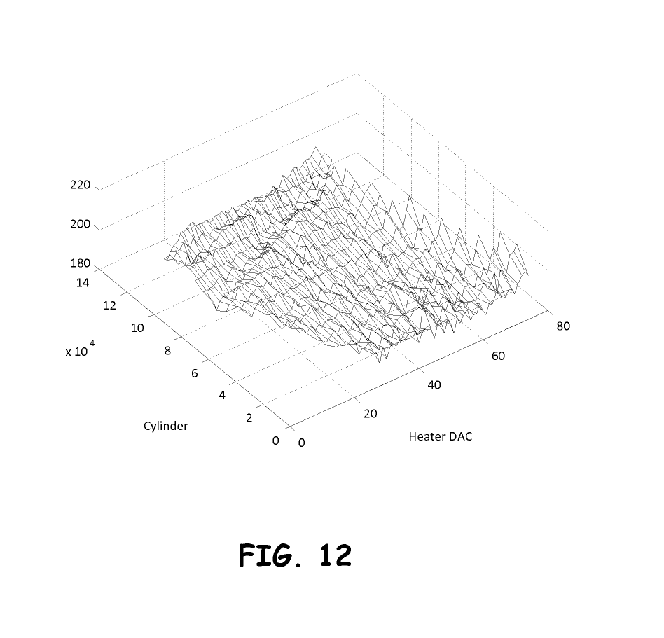

FIG. 10 is a plot showing a comparison between an AGC magnitude/phase contact detection method of one embodiment and results obtained using a legacy slider-disc contact detection method. From FIG. 10, it can be seen that AGC thresholds (inflections points) that are obtained without using complex statistics, still have the potential to sense contact earlier than a legacy method. Collecting additional data during tests show that both the magnitude and phase of the AGC experience an inflection point near the contact location. Three-dimensional plots for magnitude and phase versus heater DAC and cylinder are shown in FIGS. 11 and 12.

In a similar fashion, the PES response to swept sine data can be collected in addition to, or instead of, AGC response. However, the effects of the servo-tracking loop must be accounted for to obtain the actual position response, especially in a low frequency peaking region. In other words, an inverse sensitivity function is applied to get an actual structural response to a vertical heater disturbance. The swept sine transfer function method is suitable in system identification techniques applied to characterize a mechanical system, such as a disc drive having a dual stage actuator. The AGC transfer function magnitude as a function of frequency can be utilized to determine injection amplitudes to achieve a desired net heater protrusion. Also, measured AGC response information and measured PES response information can be utilized to obtain a combined transfer function that has units of horizontal-nm/vertical-nm.

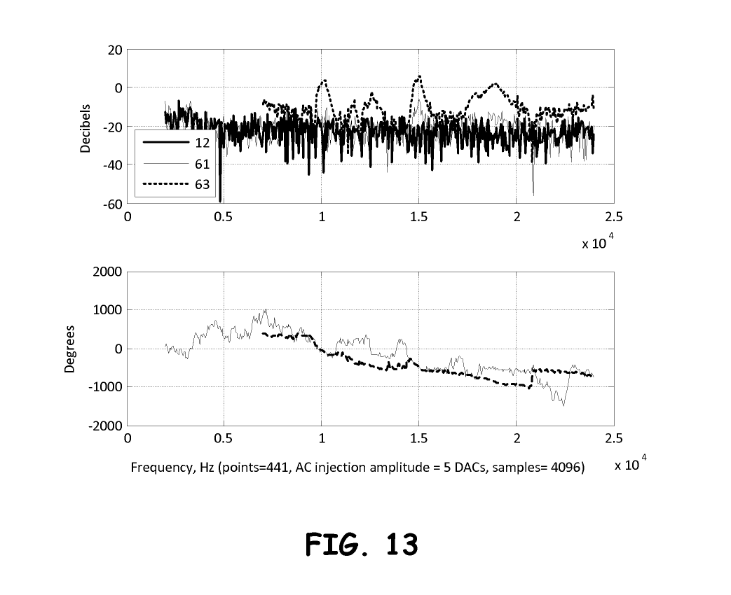

Results of this data collection show that there is no meaningful PES response observed when injecting AC heater values at a low mean value (DC) heater power. However, when the mean heater power is incremented to near the contact point, the mechanical structure is clearly observed. It is important to note that the observed structure is not expected to be equivalent to the structure measured using standard VCM current injection techniques. A plot in FIG. 13 shows a mid-radius PES response magnitude and phase at a baseline heater value (12), approaching contact (61), and near the known contact heater value (63).

It can be seen from FIG. 13 that, by measuring the response only at higher frequencies (greater that 5 times the heater bandwidth), the input disturbance of 5 DACs equates to less than one DAC of net displacement due to over 14 dB attenuation. Similar results were also seen in FIG. 6. Thus, the data can be taken closer to the known contact value of 64 DACs.

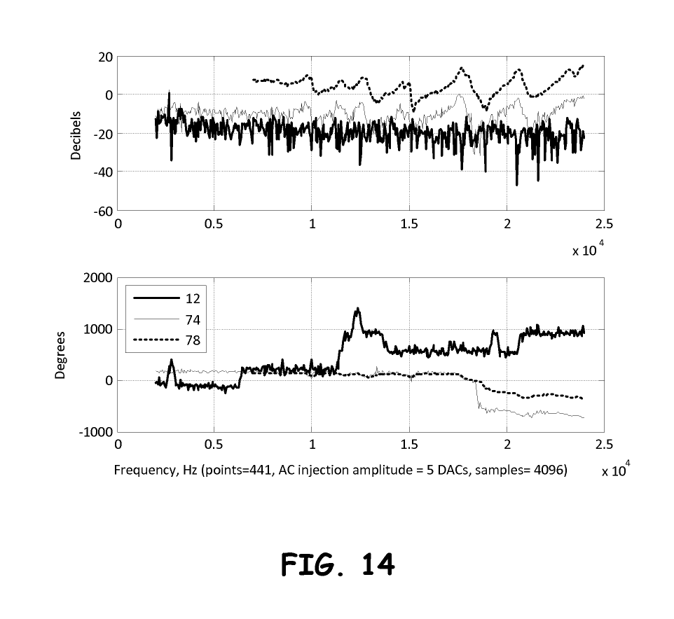

FIG. 14 is a plot of heater response (PES) for baseline and near contact at an outer radius. The result shows a much stronger response and modes present when the transfer function is measured near the known contact location. It can be seen that much more energy is observed in the heater PES response, which would enable contact proximity sensing.

Further analysis confirms that the PES heater response near zero skew is weaker than the response measured at the outer radius. Measuring contact reliably at the outer radius is typically difficult for traditional pulsed heater contact detect methods due to higher windage disturbances reducing the SNR. The AC injection slider-disc proximity detection method has a higher SNR compared with legacy slider-disc proximity detection methods.

Repeating the same measurements at the outer radius shows a strong response prior to contact of 79 DACs, as measured by legacy methods. At higher frequencies, a response is visibly seen and proximity would be sensed more than 5 DACs earlier than the legacy method. Since the PES transfer function shows a strong response prior to the contact point determined using legacy approaches, the method can be used for head proximity sensing.

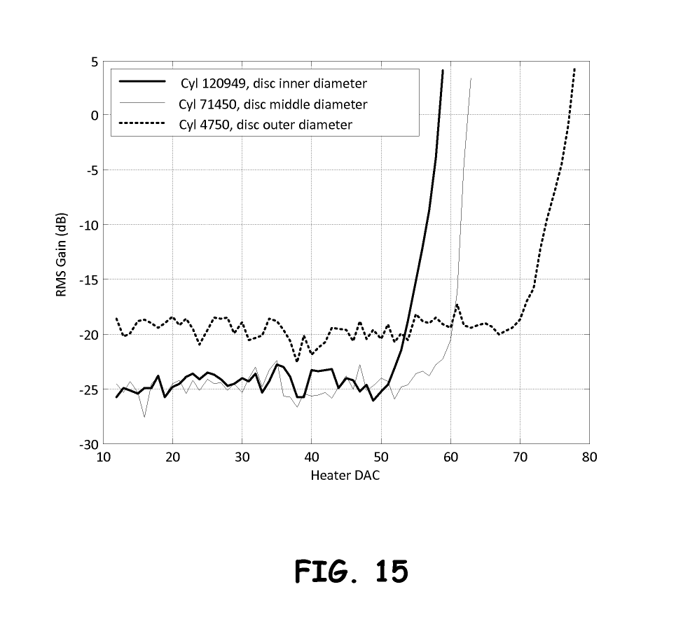

Another aspect of one or more embodiments is to use the mechanical modes measured using the heater PES swept sine response to perform contact detection and/or head proximity sensing. One detection method involves setting a threshold on the root-mean-square (RMS) of the magnitude measured in the PES response. FIG. 15, which is PES heater response RMS magnitude (from 10 to 20 kHz), versus heater DAC, shows the inflection points in the RMS magnitudes at 3 different radii. It should be noted that the vertical axis scale is gain in dB.

In one example, a choice of a single measurement frequency per head per drive, or subset of frequencies would have the advantage of reduced test time for measuring both the AGC and PES responses to sense head to disc proximity. In the above example in connection with FIG. 15, the transfer function was measured from 10 to 20 kHz, every 500 Hz, using an AC injection amplitude of 10 heater DACs using 4096 samples.

The measurement was repeated at the same 17 tracks that were used for a legacy contact detection method. A RMS gain threshold of −15 dB was used to sense the onset of head to disc contact and the results correlate to the legacy contact method. Again, at high frequency (greater than 7 times heater bandwidth), 10 DAC counts of AC injection equates to less than one DAC of net displacement.

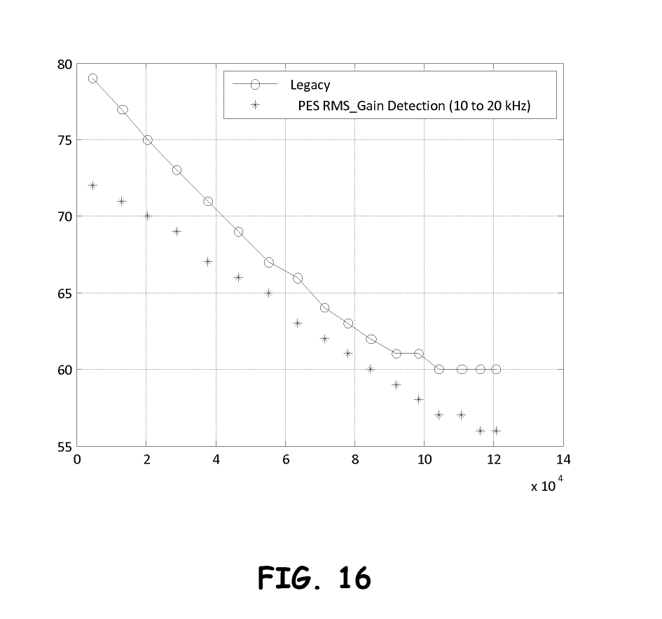

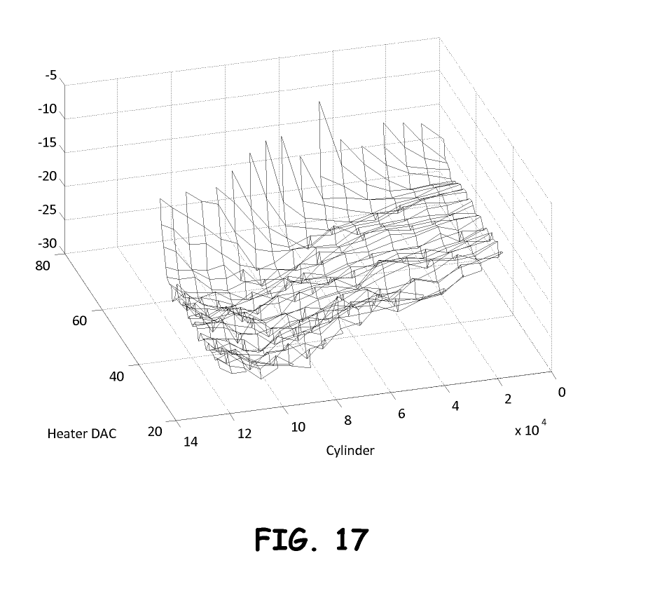

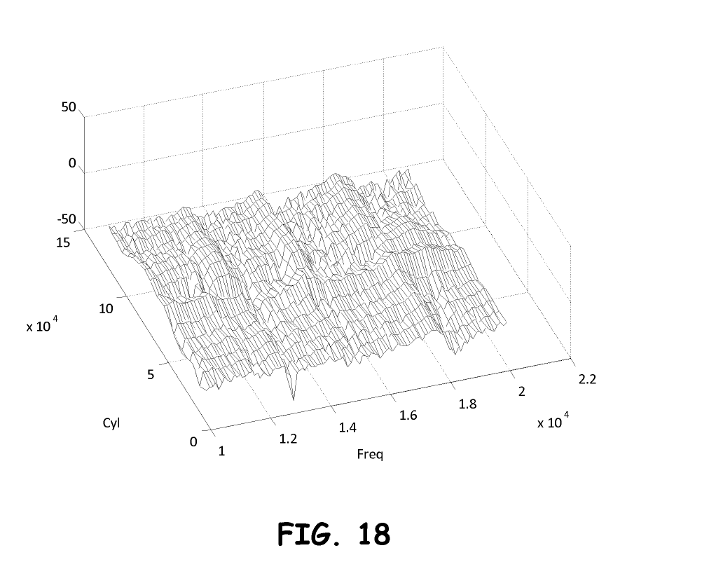

FIG. 16 is a plot showing slider-disc proximity sensing using RMS gain as compared to a legacy slider-disc proximity sensing method. This plot includes RMS gain data versus heater DAC and cylinder. It can be seen that the knee in the curve is being sensed with a very aggressive threshold (−15 dB). Setting a low threshold is possible due to the high signal to noise ratio of the AC injection method, which is less prone to a false contact detection. Raising the threshold would most likely result in a more legacy like contact profile. In addition, a statistical approach would allow a more accurate threshold to be set if desired. FIG. 17 is a 3 dimensional plot showing the RMS gains versus cylinder and Heater DAC. FIG. 18 is a 3 dimensional PES response magnitude frequency spectrum near the slider-disc contact point as a function of disc radius.

An additional aspect of one or more embodiments is to characterize the mechanical modes observed via the heater PES swept sine response. Once the information is learned via a swept sine, a single frequency or subset of frequencies, representing a mechanical mode(s) and the corresponding gain(s) would be saved in non-volatile memory (flash/disc) as a function of radius for future use. For example, the saved information would be utilized for real-time proximity sensing and fly height adjustment during drive operation. In addition, the structure information would be utilized for manufacturing process monitoring and for refinement of the mechanical design.

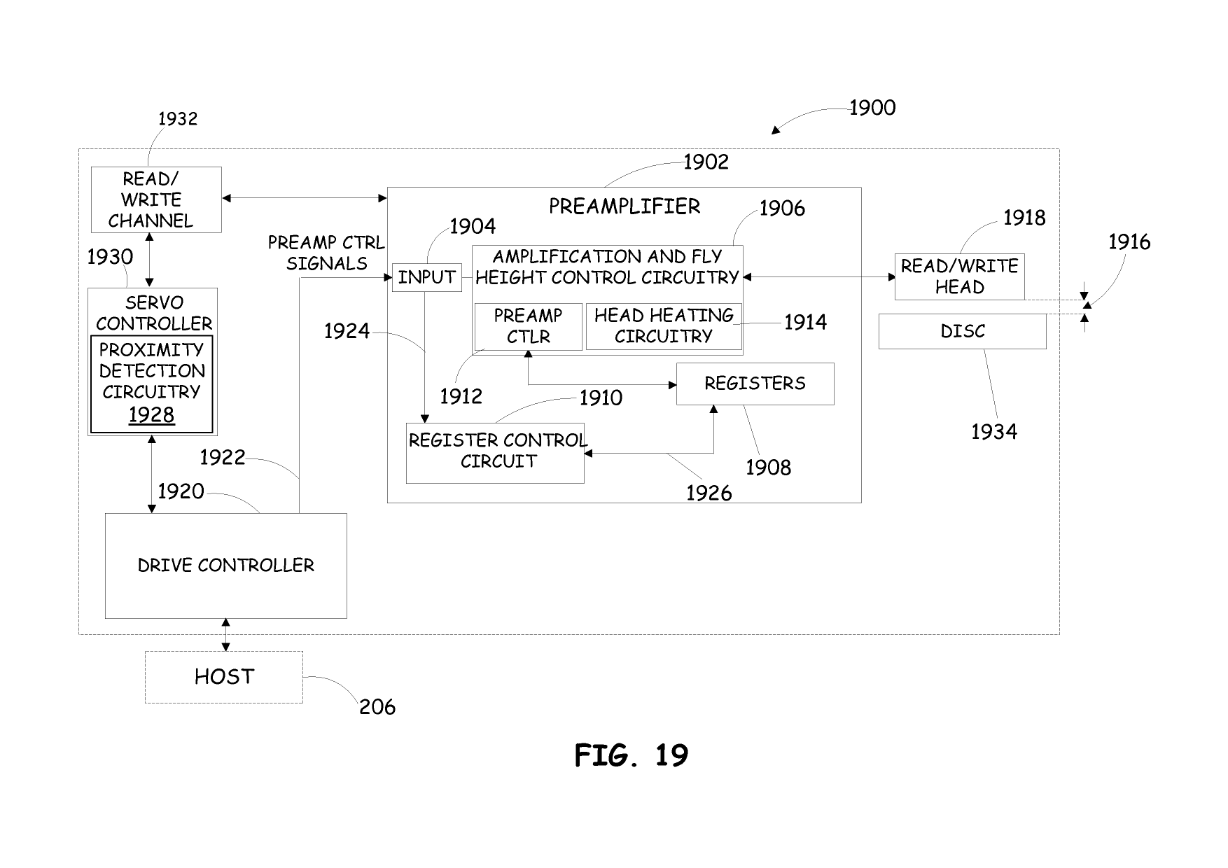

In summary, referring now to FIG. 19, a simplified block diagram of a disc storage system 1900 that includes circuitry that provides an AC signal injection to a heater of a head/slider and circuitry that detects head/slider-disc proximity when the AC injection signal is being provided to the slider, is shown. As can be seen in FIG. 19, preamplifier 1902 includes an input 1904, signal amplification and fly height control circuitry 1906, registers 1908 and register control circuit 1910. Portions of preamplifier 1902 may be realized by way of more than one integrated circuit or discrete components, or integrated into a large scale integrated circuit. In preamplifier 1902, circuitry 1906 includes a preamplifier and fly height controller 1912 and a slider or head-heating circuit 1914, which is used to adjust fly height 1916. Head heating circuitry 1914 can include, for example, a circuit that provides an electrical current (voltage or power) to a resistive heating element (not shown) in head/slider 1918. Preamplifier controller 1912 enables/disables (or turns on/shuts off) and controls different circuits within component 1906 based on contents of registers 1908 and preamplifier control signals that it receives via input 1904, which, in turn, receives the preamplifier control signals from drive controller 1920 via control line 1922. Control line 1922 can comprise multiple hardware lines. Register control circuit 208 is coupled to input 202 and registers 206 via control lines 218 and 220, respectively. Register control circuit 1910 can receive instructions from drive controller 1920, via input 1904, and accordingly update registers 1908. For example, instructions received from drive controller 1920 can include instructions to vary DAC values in registers 1908 in a manner that would result in head-heating circuit 1914 providing an AC injection signal to head/slider 1918. As indicated above, disc storage system 1900 includes head-disc proximity detection circuitry 1928. In the embodiment of FIG. 19, circuitry 1928 is within servo controller 1930, which receives sensed signals via preamplifier 1902 and read channel 1932. Servo controller 1930 samples PES and AGC signals and obtains amplitude and position of each servo wedge on a surface of disc 1934. This information is used by proximity detection circuitry to obtain a transfer function of the AC signal for position and magnitude. Thus, a slider-disc proximity sensing operation involves dive controller 1920 instructing register control circuitry 1910 to update registers 1908 with DAC values that result in head-heating circuitry 1914 injecting an AC signal (for example, a swept sine signal) along with a baseline DC current to the head heater. While AC signal injection is occurring, transfer functions for position (PES) and amplitude (AGC) are computed by proximity detection circuitry 1928. During AC injection, in one embodiment, the DC current supplied to the heater is incremented in steps by appropriately changing DAC values in registers 1908 while proximity detection circuitry 1928 is monitoring for near-contact or contact between slider 1918 and disc 1934. Proximity detection circuitry 1928 detects slider-disc proximity when there is a change in the transfer function for position and/or amplitude. It should be noted that, in some embodiments, instead of or in addition to varying DAC values to produce AC injection, an AC circuit capable of providing the necessary signal injection is utilized. Other methods can also be used. Further, it should be noted that the principles of the disclosure apply to sensors that include a read mechanism and/or a write mechanism.

It is to be understood that even though numerous characteristics and advantages of various embodiments have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. For example, the particular elements may vary depending on the particular type of system (disc drive, spinstand tester, etc.) in which the sensor-object proximity detection technique is used without departing from the spirit and scope of the present disclosure.

What is claimed is:

1. An apparatus comprising:
a sensor comprising a heater;
a proximity detection component configured to analyze a sensed signal, obtained from the sensor during application of an alternating current signal to the heater of the sensor, and to responsively provide an output indicative of whether proximity exists between the sensor and an object that causes the sensor to produce the sensed signal,
wherein the heater mechanically displaces at least a portion of the sensor vertically in response to the application of the alternating current signal.

2. The apparatus of claim 1 wherein the sensor comprises a read mechanism and the object comprises a data storage medium.

3. The apparatus of claim 2 wherein the sensed signal provided from the read mechanism is a readback signal.

4. The apparatus of claim 3 wherein the data storage medium comprises servo sectors that include automatic gain control fields.

5. The apparatus of claim 4 wherein the proximity detection component utilizes amplitude values of the readback signal obtained from reading the automatic gain control fields to determine whether proximity exists between the read mechanism and the data storage medium.

6. The apparatus of claim 3 wherein the data storage medium comprises servo sectors that include position error signal fields.

7. The apparatus of claim 6 wherein the proximity detection component utilizes position values of the readback signal obtained from reading the position error signal fields to determine whether proximity exists between the read mechanism and the data storage medium.

8. The apparatus of claim 3 wherein the data storage medium comprises servo sectors that include automatic gain control fields and position error signal fields.

9. The apparatus of claim 8 wherein the proximity detection component utilizes amplitude values of the readback signal obtained from reading the automatic gain control fields and position values of the readback signal obtained from reading the position error signal fields to determine whether proximity exists between the read mechanism and the data storage medium.

10. The apparatus of claim 1 wherein the alternating current signal is a swept sinusoidal signal.

11. A circuit comprising:
a proximity detection component configured to analyze a sensed signal, obtained from a sensor during application of an alternating current signal to a heater of the sensor, and to responsively provide an output indicative of whether proximity exists between the sensor and an object that causes the sensor to produce the sensed signal,
wherein the sensor is electrically coupled to a suspension that supports the sensor via a low impedance coupling.

12. The circuit of claim 11 wherein the sensor comprises a read mechanism and the object comprises a data storage medium.

13. The circuit of claim 12 wherein the sensed signal provided from the read mechanism is a readback signal.

14. The circuit of claim 13 wherein the data storage medium comprises servo sectors that include automatic gain control fields and position error signal fields.

15. The circuit of claim 14 wherein the proximity detection component utilizes amplitude values of the readback signal obtained from reading the automatic gain control fields to determine whether proximity exists between the read mechanism and the data storage medium.

16. The circuit of claim 14 wherein the proximity detection component utilizes position values of the readback signal obtained from reading the position error signal fields to determine whether proximity exists between the read mechanism and the data storage medium.

17. The circuit of claim 14 wherein the proximity detection component utilizes amplitude values of the readback signal obtained from reading the automatic gain control fields and position values of the readback signal obtained from reading the position error signal fields to determine whether proximity exists between the read mechanism and the data storage medium.

18. The circuit of claim 12 wherein the sensor further comprises a write mechanism.

19. An apparatus comprising:
a first circuit configured to provide an alternating current signal to a heater of a sensor, the alternating current signal causes the heater of the sensor to mechanically displace the sensor vertically; and
a second circuit configured to analyze a sensed signal, obtained from the sensor during application of the alternating current signal to the heater of the sensor, and to responsively provide an output indicative of whether proximity exists between the sensor and an object that causes the sensor to produce the sensed signal.

20. The apparatus of claim 19 wherein the alternating current signal is a swept sinusoidal signal.
